(19) United States
(12) Patent Application Publication
(10) Pub. No.: US 2026/0019850 A1
(43) Pub. Date: Jan. 15, 2026

(54) METHOD AND APPARATUS FOR MEASUREMENT REPORTING

(71) Applicant: Telefonaktiebolaget LM Ericsson (publ), Stockholm (SE)

(72) Inventors: Muhammad Ali KAZMI, Reston, VA (US); Venkatarao GONUGUNTLA, Sundbyberg (SE); Zhanxian WANG, Täby (SE); Pontus WALLENTIN, Linköping (SE); Antonino ORSINO, Kirkkonummi (FI); Jens BERGQVIST, Linköping (SE)

(21) Appl. No.: 18/881,889

(22) PCT Filed: Jul. 5, 2023
(86) PCT No.: PCT/SE2023/050710

§ 371 Date: Jan. 7, 2025

Related U.S. Application Data
(60) Provisional application No. 63/392,277, filed on Jul. 26, 2022.

(51) Int. Cl. H04W 24/10; H04W 76/27

(52) U.S. Cl. CPC H04W 24/10; H04W 76/27

(57) ABSTRACT

A method and apparatus are disclosed. A network node configured to communicate with a wireless device (WD) is described. The network node is configured to, and/or includes a radio interface and/or includes processing circuitry configured to: determine a configuration including at least a first timer and additional information, where the configuration is usable by the WD to perform at least one measurement associated with early measurement reporting based at least on the first timer and the additional information; transmit the configuration to the WD; and receive, from the WD, a report including the at least one measurement based at least on the first timer and the additional information.

### FIELD

The present disclosure relates to wireless communications, and in particular, to performing measurement(s) and/or measurement reporting in a wireless communication network.

### INTRODUCTION

The Third Generation Partnership Project (3GPP) has developed and is developing standards for Fourth Generation (4G) (also referred to as Long Term Evolution (LTE)) and Fifth Generation (5G) (also referred to as New Radio (NR)) and Sixth Generation (6G) wireless communication systems. Such systems provide, among other features, broadband communication between network nodes, such as base stations, and mobile wireless devices (WD), as well as communication between network nodes and between WDs.

### NR Operation in Mm Wave Frequency

NR may be operated in wide range of frequencies such as frequency range 1 (FR1) and frequency range 2 (FR2). FR1 includes frequency bands in a range from 410 MHz to 7125 MHz and may also be called sub 6 GHz. FR2 may be divided in two subband such as FR2-1 and FR2-2, where FR2-1 is from 24250 MHz-52600 MHz, and FR2-2 is above 71.6 GHz. The frequency range of FR2 may also be called above n “above-6-GHz range” and/or referred to as a millimeter wave (mmWave) bands/frequency.

### Multi-Carrier Operation

In multicarrier (MC) operation, the WD operates with at least two serving cells belonging to their respective serving carrier frequencies. Examples of MC operations are carrier aggregation (CA), dual connectivity (DC), multi-connectivity (MuC), etc. The carrier frequency is also called as component carrier (CC), frequency layer, serving carrier, frequency channel, etc. Examples of serving cells are special cell (sPCell), secondary cell (SCell), etc. Examples of SpCell are primary cell (PCell), primary secondary cell (PSCell), etc. The carrier frequencies of SpCell, SCell, PCell and PSCell are called special Component Carrier (SpCC or SpC), secondary CC (SCC), primary CC (PCC) and primary secondary CC (PSCC or PSC), respectively.

In carrier aggregation (CA), the WD is configured with one primary serving cell (i.e., PCell) and one or more secondary serving cells (i.e., SCells). In dual connectivity (DC), the WD is configured with a master cell group (MCG) which may include at least a PCell and a secondary cell group (SCG) that may include at least a PSCell. Each of MCG and SCG may further include one or more SCells. The PCell manages (e.g., configures, changes, releases, etc.) SCells in MCG and PSCell in SCG. PSCell may also manage SCells in SCG. The cells in MCG and SCG may belong to the same radio access technology (RAT) (e.g., all cells are NR in both MCG and SCG like in NR-DC). Further, the cells in MCG and SCG may belong to different RATs (e.g., LTE cells in MCG and NR cells in SCG such as in enhanced universal terrestrial radio access dual connectivity (EN-DC) or NR cells in MCG and LTE cells in SCG such as in NR enhanced universal terrestrial radio access dual connectivity (NE-DC)). NR CA and MR-DC (Multi-Radio Dual Connectivity, including NR-DC, EN-DC, and NE-DC) are examples of multi-carrier operation in NR.

### WD Measurements

The WD may perform measurements on one or more downlink DL and/or uplink UL reference signal (RS) of one or more cells in different WD activity states e.g., radio resource control (RRC) idle state, RRC inactive state, RRC connected state etc. The measured cell may belong to or operate on the same carrier frequency as of the serving cell (e.g., intra-frequency carrier). Further, the measured cell may belong to or operate on different carrier frequency as of the serving cell (e.g., non-serving carrier frequency). The non-serving carrier may be called inter-frequency carrier if the serving and measured cells belong to the same RAT but different carriers. The non-serving carrier may be called inter-RAT carrier if the serving and measured cells belong to different RATs. Examples of downlink RS are signals in synchronization signal/physical broadcast control channel (SS/PBCH) block (SSB), channel state information reference signal (CSI-RS), cell specific reference signal (CRS), demodulation reference signal (DMRS), primary SS (PSS), secondary SS (SSS), signals in SS/PBCH block (SSB), discovery reference signal (DRS), positioning reference signal (PRS), etc. Examples of uplink RS are signals in sounding reference signal (SRS), DMRS etc.

Each SSB carries NR-PSS, NR-SSS and NR-PBCH in four successive symbols. One or multiple SSBs may be transmitted in one SSB burst which may be repeated with a predetermined periodicity e.g., 5 ms, 10 ms, 20 ms, 40 ms, 80 ms and 160 ms. The WD may be configured with information about SSB on cells of certain carrier frequency by one or more SS/PBCH block measurement timing configuration (SMTC) configurations. The SMTC configuration may include parameters such as SMTC periodicity, SMTC occasion length in time or duration, SMTC time offset with respect to reference time (e.g., serving cell system frame number (SFN)), etc. Therefore, SMTC occasion may also occur with certain periodicity e.g., 5 ms, 10 ms, 20 ms, 40 ms, 80 ms and 160 ms.

Examples of measurements may be cell identification (e.g. physical cell Id (PCI) acquisition, PSS/SSS detection, cell detection, cell search, etc.), Reference Symbol Received Power (RSRP), Reference Symbol Received Quality (RSRQ), secondary synchronization RSRP (SS-RSRP), SS-RSRQ, Signal to Interference Noise Ratio (SINR), RS-SINR, SS-SINR, CSI-RSRP, CSI-RSRQ, received signal strength indicator (RSSI), acquisition of system information (SI), cell global ID (CGI) acquisition, Reference Signal Time Difference (RSTD), user equipment receive-transmit (UE RX-TX) time difference measurement, Radio Link Monitoring (RLM), which consists of Out of Synchronization (out of sync) detection and In Synchronization (in-sync) detection, etc. In the present disclosure, UE and WD may be used interchangeably.

The WD is typically configured by the network node via signaling (e.g., via RRC message) with measurement configuration and measurement reporting configuration such as measurement gap pattern, carrier frequency information, types of measurements (e.g., RSRP), higher layer filtering coefficient, time to trigger report, reporting mechanism (e.g., periodic, event triggered reporting, event triggered periodic reporting), etc.

### Early Measurement Reporting

A purpose of early measurement reporting (EMR) is to enable fast multi-carrier configuration for the WD. It is important that up-to-date measurements which are reflecting the most recent WD radio conditions are reported. An EMR measurement may comprise one or more of a cell or beam measurement results, e.g., a power-based measurement (similar to RSRP, RSRQ, SINR, SNR, internet of things (Es/IoT), etc.), a timing measurement (similar to round trip time (RTT), receive-transmit (Rx-Tx) time, time of arrival (ToA)), cell index or PCI or beam index (such as best cell/beam index or set of cells/beams measured to be above a threshold), etc.

### New Radio

In 3GPP Release 16 (Rel-16), early measurement reporting was introduced for measurements on enhanced universal terrestrial radio access (E-UTRA) and NR carriers to facilitate multi-carrier operation with NR, e.g., NR CA or MR-DC. The measurements can be performed in operation modes such as RRC_IDLE or RRC_INACTIVE. The purpose of early measurement reporting mechanism is to enable a network node (NN) (e.g., serving cell) to receive the measurement report as soon as the WD is in RRC connected state. This allows the NN to configure the WD with multicarrier operation e.g., with CA configuration and/or DC configuration (e.g., SCG setup). In general, an early measurement report can be sent after security activation, implying that the WD coming from RRC_IDLE can send EMR after a command such as SecurityModeCommand. The WD coming from RRC_IDLE with stored context can send after processing the RRC Resume message. Further, the WD coming from NR RRC_INACTIVE can send after transmission of the RRC Resume Request message (i.e., before reception of the RRC Resume message).

FIGS. 1 and 2 show an example of a typical EMR framework in NR Rel-16. More specifically, FIG. 1 shows a typical early measurement reporting from NR RRC_IDLE. FIG. 2 shows a typical early measurement reporting from NR RRC_INACTIVE. For RRC_IDLE, as shown in FIG. 1, the NN may configure the WD with early measurement configuration. Based on the cell on which WD is camped in the IDLE mode, if the cell supports EMR (e.g., WD may read SIB information to know whether the cell supports EMR or not), the WD performs the early measurements when the T331 timer is running.

In scenario 1, the WD may need to transition to connected mode before the timer expires or after (e.g., shortly after) the timer expires. In this case, the NN may request the WD for (i.e., to perform) early measurements. Since the WD was measuring (e.g., mandatorily measuring) for an early measurement report, the WD reports the EMR in the RRC connection setup complete message. The NN may use the EMR information to configure the CA or DC configuration for the WD.

In scenario 2, the WD may need to transition to connected mode after the T331 timer expires. The WD may or may not continue performing the early measurements as per the NN configuration during RRC release. In this scenario, the NN may request the WD for early measurements. If the WD was measuring the early measurements after the T331 expiry, or the NN request is Xms after the timer expiry, the WD reports the EMR in the RRC connection setup complete message. The NN may use the EMR information to configure the CA or DC configuration for the WD.

However, typical systems suffer from one or more problems including, but not limited to:
Problem 1: For early measurement reporting, the WD is configured with timer T331, which may be up to e.g., 300 seconds (5 minutes), during which the WD is required to perform measurements for early measurement reporting. As per 3GPP Technical Standard (TS) 38.133, Table 4.2.2.4-1 (as shown in FIG. 3), for a FR2 cell, cell detection and measurement take approximately 2.5 minutes (i.e., the 2.5 minutes requirement can be very long in some scenarios).
Problem 2: Generally, a cell is known to the WD for a predetermined time period (e.g., 5 seconds) after it has been measured last time. If more than 5 seconds elapse, the WD may need to re-identify the cell prior to performing measurements on the cell in order to guarantee measurement performance. The maximum value of a timer such as timer T331 is longer than 5 seconds, which may result in the WD measuring an unknown cell which in turn may result in poor measurement quality (and/or, the WD may perform measurements on a wrong cell).
Problem 3: Traffic is often bursty in nature (i.e., traffic has frequent bursts). Depending on the network strategy for WD power saving, the network node may typically bring the WD to RRC_IDLE or RRC_INACTIVE when there is no traffic for certain time. Further, when there is a traffic burst, the NN brings the WD back to RRC_CONNECTED state. However, due to the traffic burstiness, a WD may spend shorter time in RRC_IDLE or RRC_INACTIVE than the time required for the WD to perform cell detection, measurement and evaluation for the early measurements. In other words, during transition back to RRC_CONNECTED (e.g., triggered by available user data), a WD, in some scenarios, may not be able to provide any measurements (or at least a small subset of the measurements it is expected to report).

### SUMMARY

Some embodiments advantageously provide methods, systems, and apparatuses for enhanced early measurement reporting, e.g., for FR2.

In some embodiments, a first solution includes determining a new WD idle/inactive mode measurement behavior (early measurement behavior) for a predetermined period of time during idle or inactive mode, in which the WD is to perform periodic measurements as in connected mode.

In a first embodiment of the first solution, methods in the WD for timer-adaptive measurement procedure for EMR measurements are described. In a second embodiment of the first solution, methods in the WD for timer-adaptive procedure for EMR measurements which further account for the known status of the cell or beam to be measured for EMR purposes. In a third embodiment of the first solution, methods in a network node (e.g., corresponding to the methods in the WD) are described.

In some other embodiments, a second solution includes determining and/or performing idle/inactive mode measurements that are accumulated over multiple periods in which the WD is idle or inactive. Between each of these periods, the WD may be in another state, such as connected mode.

In an embodiment, a method in a WD, e.g., to perform early measurements in idle or inactive mode, is described. The method may include one or more of:
Receiving, from a network node, an early measurements configuration of at least a first timer, the carriers on which EMR needs (e.g., is expected) to be performed, etc. In one example, the first timer is a T331 timer (i.e., idle mode measurement timer) which may be the T331 timer described in 3GPP TS 38.331.
Performing measurements according to the received early measurements configuration and according to a performance requirement/target.
Reporting, to a network node, measurement results obtained during the performed early measurements.

In another embodiment, a method in a network node, e.g., to control early measurements in idle or inactive mode performed by a WD, is described. The method may include one or more of:
Transmitting, to the WD, an early measurements configuration of at least a first timer, the carriers on which EMR needs to be performed, etc. In one example, In one example, the first timer is a T331 timer (i.e., idle mode measurement timer) which may be the T331 timer described in 3GPP TS 38.331.
Receiving, from the WD, measurement results obtained during measurements according to the transmitted early measurements configuration and/or according to a performance requirement/target.

In some embodiments, a new WD behavior is introduced such as for a certain period of time during idle mode, where the WD is required (i.e., expected) to perform more periodic measurements like connected mode.

One or more embodiments of the present disclosure are beneficial at least because:
Enhanced EMR performance in FR2 may be achieved when compared to typical systems;
EMR may be available when a T331 timer is stopped and/or when an RRC connection is resumed.
Lesser measurement period of cell(s) can be achieved under predetermined conditions, thereby enabling better EMR performance for certain scenarios when compared to typical systems.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 shows a typical early measurement reporting;

FIG. 2 shows another typical early measurement reporting;

FIG. 3 shows a table of typical measurement times;

FIG. 4 is a schematic diagram of an example network architecture illustrating a communication system connected via an intermediate network to a host computer according to the principles in the present disclosure;

FIG. 5 is a block diagram of a host computer communicating via a network node with a wireless device over an at least partially wireless connection according to some embodiments of the present disclosure;

FIG. 6 is a flowchart illustrating example methods implemented in a communication system including a host computer, a network node and a wireless device for executing a client application at a wireless device according to some embodiments of the present disclosure;

FIG. 7 is a flowchart illustrating example methods implemented in a communication system including a host computer, a network node and a wireless device for receiving user data at a wireless device according to some embodiments of the present disclosure;

FIG. 8 is a flowchart illustrating example methods implemented in a communication system including a host computer, a network node and a wireless device for receiving user data from the wireless device at a host computer according to some embodiments of the present disclosure;

FIG. 9 is a flowchart illustrating example methods implemented in a communication system including a host computer, a network node and a wireless device for receiving user data at a host computer according to some embodiments of the present disclosure;

FIG. 10 is a flowchart of an example process in a network node according to some embodiments of the present disclosure; and

FIG. 11 is a flowchart of an example process in a wireless device according to some embodiments of the present disclosure.

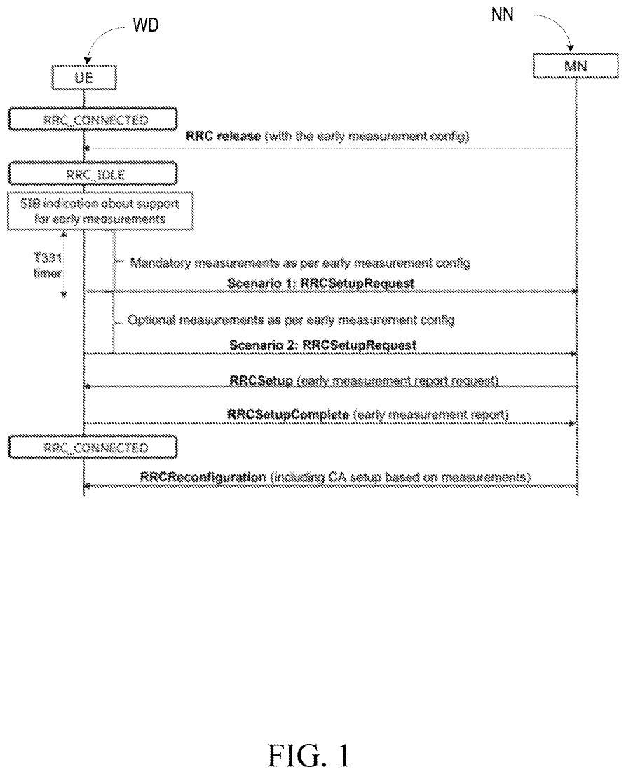

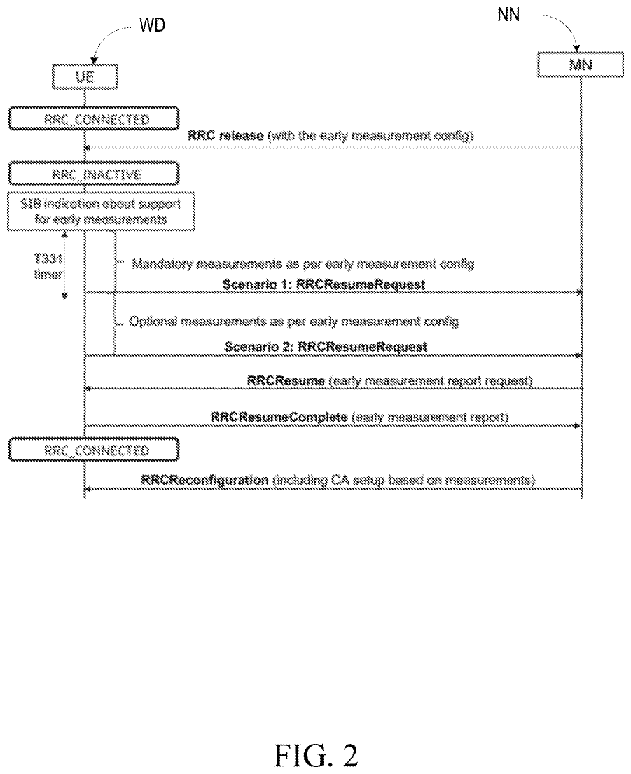

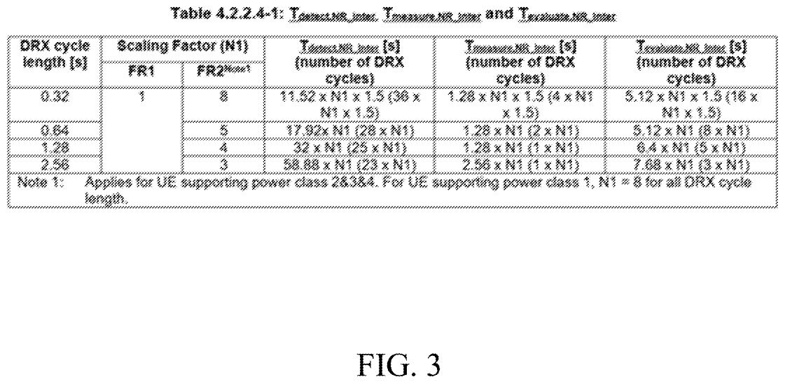

### DETAILED DESCRIPTION

Before describing in detail example embodiments, it is noted that the embodiments reside primarily in combinations of apparatus components and processing steps related to early measurement reporting, e.g., for FR2. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate, and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS)(such as an NR base station), radio base station, base transceiver station (BTS), base station controller (BSC), network controller, radio network controller (RNC), g Node B (gNB), evolved Node B (eNB or eNodeB), ng-eNB, Node B, multi-standard radio (MSR) radio node such as MSR BS, transmission reception point (TRP), multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), location server, an external node (e.g., 3rd party node, a node external to the current network), Enhanced Serving Mobile Location Center (E-SMLC), nodes in distributed antenna system (DAS), a spectrum access system (SAS) node, an element management system (EMS), etc. The network node may also comprise test equipment (physical node or software). In some embodiments, the term “network node” may correspond to any type of radio network node or any network node, e.g., which communicates with a WD and/or with another network node. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD), e.g., in a in a cellular or mobile communication system. The WD may also be a radio communication device, target device, device to device (D2D) WD, machine type WD or WD capable of machine-to-machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc. Some nonlimiting examples of WDs include wireless device supporting NR, target device, device to device (D2D) WD, machine type WD or WD capable of machine to machine (M2M) communication, PDA, PAD, Tablet, mobile terminals, smart phone, laptop embedded equipped (LEE), laptop mounted equipment (LME), drone, USB dongles, ProSe UE, vehicle to vehicle (V2V) WD, vehicle to everything (V2X) WD, etc.

Also, in some embodiments the term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

The term time resource may refer to any type of physical resource or radio resource expressed in terms of length of time or time interval or time duration. Examples of time resources are symbol, mini-slot, time slot, subframe, radio frame, TTI, interleaving time, etc.

The term transmission time interval (TTI) used herein may correspond to any time period over which a physical channel can be encoded and interleaved for transmission. A physical channel may be decoded by the receiver over the same time period (e.g., T0) over which it was encoded. The TTI may also interchangeably called as short TTI (sTTI), transmission time, slot, sub-slot, mini-slot, short subframe (SSF), mini-subframe, etc.

One or more embodiments are described for multi-carrier operation with NR, including intra-RAT multi-carrier operation and inter-RAT multi-carrier operation (e.g., EN-DC or NE-DC). However, the embodiments are applicable to earlier measurement reporting with any other single-RAT or multi-RAT systems, where a WD receives and/or transmit signals (e.g., data) e.g., NR, LTE frequency division duplex (FDD)/time division duplex (TDD), Wide band Code Division Multiple Access (WCDMA)/High Speed Packed Access (HSPA), WiFi, wireless local area network (WLAN), LTE, 5G, etc.

The term early measurement report (EMR) (or early measurement) may also refer to low activity RRC state measurement report, low activity RRC state measurement, etc. Examples of low activity RRC states are RRC idle state, RRC inactive state, etc. An example of high activity RRC state is RRC connected state. Examples of low activity RRC state measurement are idle and/or inactive measurements, idle and/or inactive multicarrier measurements, idle and/or inactive measurements for multicarrier operation, idle and/or inactive CA/DC measurement, idle and/or inactive measurement for CA and/or DC, etc.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Carrier frequencies on which the WD is configured to perform early measurement may belong to certain frequency range (FR). Examples of FR are within frequency range 1 (FR1), within frequency range 2 (FR2), within frequency range 3 (FR3), etc. In one example, frequencies within FR2 are frequencies above certain threshold, e.g., 24 GHz or higher. In another example, the frequencies in FR2 may vary between 24 GHz to 52.6 GHz. In another example, frequencies in FR2 may vary between 24 GHz to 71 GHz. Frequencies in FR1 may be below the frequencies in FR2. In one example, frequencies in FR1 range between 410 MHz and 7125 MHz. In higher frequencies (e.g., mmWave, FR2, FR3, etc.) due to higher signal dispersion, the transmitted signals may be beamformed by a base station, e.g., transmitted in terms of SSB beams. The beam-based transmission and/or reception may also be used in lower frequencies, e.g., in FR1. The WD may create a receive beam at its receiver to receive the signal (e.g., SSB). A DL RS (e.g., SSB, CSI-RS, etc.) may interchangeably be called as a DL beam, spatial filter, spatial domain transmission filter, main lobe of the radiation pattern of antenna array, etc. The RS or beams may be addressed or configured by an identifier, which can indicate the location of the beam in time in beam pattern, e.g., beam index such as SSB index indicate SSB beam location in the pre-defined SSB format/pattern. For example, the term beam used herein may refer to RS such as SSB, CSI-RS etc. The measurement on such RS may also be refer to beam measurement or beam-based measurement. The WD (and/or any network node) may combine two or more beam measurements to obtain cell level measurement result.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

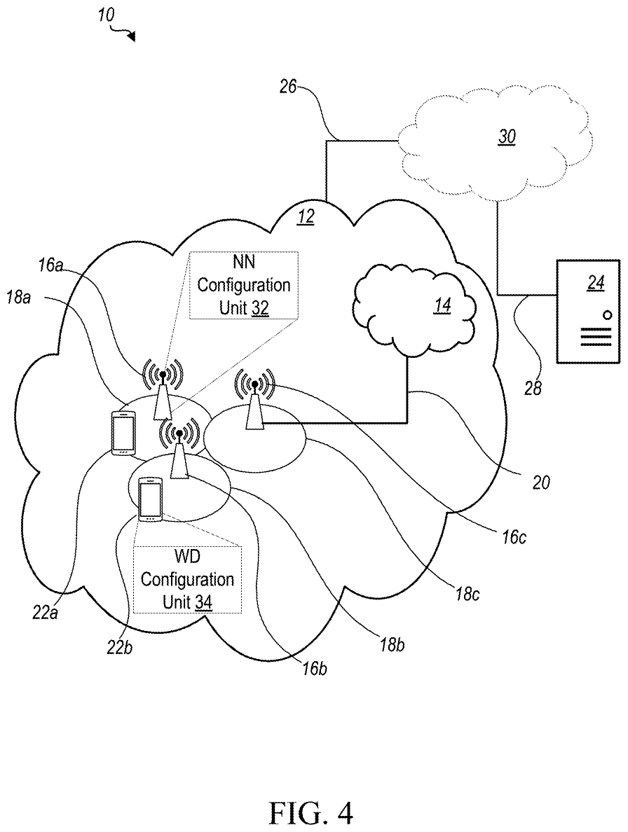

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein. Referring again to the drawing figures, in which like elements are referred to by like reference numerals, there is shown in FIG. 4 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 4 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a NN configuration unit 32 which is configured to perform any step and/or task and/or process and/or method and/or feature described in the present disclosure, e.g., determine a configuration including at least a first timer and additional information, the configuration being usable by the WD to perform at least one measurement associated with early measurement reporting based at least on the first timer and the additional information. A wireless device 22 is configured to include a WD configuration unit 34 which is configured to perform any step and/or task and/or process and/or method and/or feature described in the present disclosure, e.g., perform the at least one measurement based at least on a first timer and additional information; and cause the WD 22 to transmit, to the network node 16, a report including the performed at least one measurement.

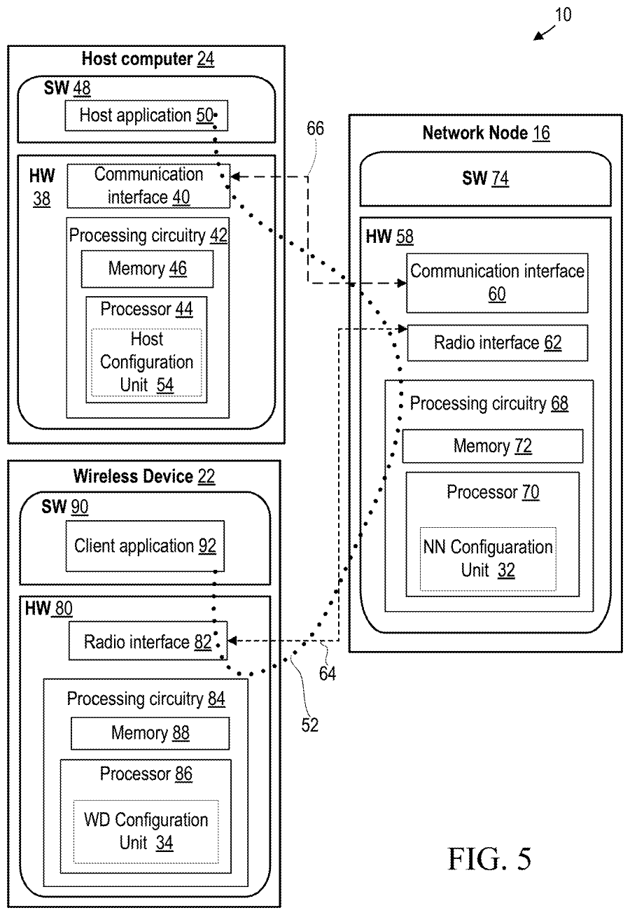

Example implementations, in accordance with an embodiment, of the WD 22, network node 16 and host computer 24 discussed in the preceding paragraphs will now be described with reference to FIG. 5. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a host configuration unit 54 configured to perform any step and/or task and/or process and/or method and/or feature described in the present disclosure, e.g., enable the service provider to observe/monitor/control/transmit to/receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a NN configuration unit 32 which is configured to perform any step and/or task and/or process and/or method and/or feature described in the present disclosure, e.g., determine a configuration including at least a first timer and additional information, the configuration being usable by the WD to perform at least one measurement associated with early measurement reporting based at least on the first timer and the additional information.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include WD configuration unit 34 which is configured to perform any step and/or task and/or process and/or method and/or feature described in the present disclosure, e.g., perform the at least one measurement based at least on a first timer and additional information; and cause the WD 22 to transmit, to the network node 16, a report including the performed at least one measurement.

In some embodiments, the inner workings of the network node 16, WD 22, and host computer 24 may be as shown in FIG. 5 and independently, the surrounding network topology may be that of FIG. 4.

In FIG. 5, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 4 and 5 show various “units” such as NN configuration unit 32, and WD configuration unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

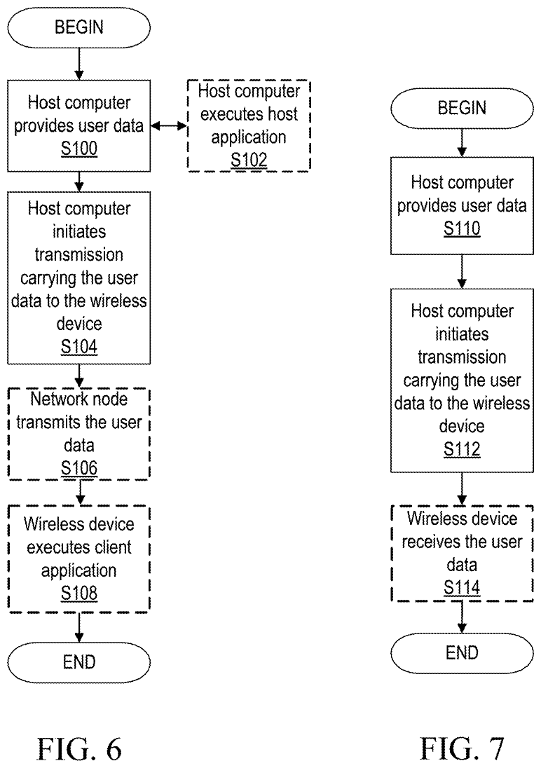

FIG. 6 is a flowchart illustrating an example method implemented in a communication system, such as, for example, the communication system of FIGS. 4 and 5, in accordance with one embodiment. The communication system may include a host computer 24, a network node 16 and a WD 22, which may be those described with reference to FIG. 5. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 7 is a flowchart illustrating an example method implemented in a communication system, such as, for example, the communication system of FIG. 4, in accordance with one embodiment. The communication system may include a host computer 24, a network node 16 and a WD 22, which may be those described with reference to FIGS. 4 and 5. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

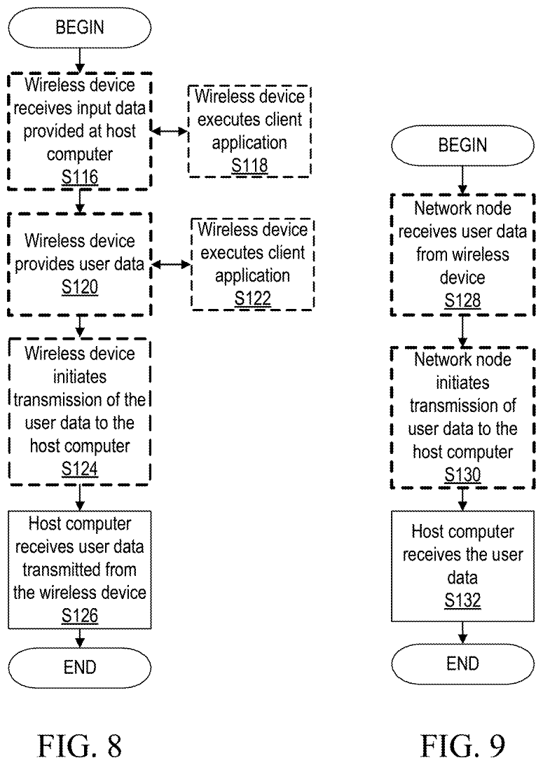

FIG. 8 is a flowchart illustrating an example method implemented in a communication system, such as, for example, the communication system of FIG. 4, in accordance with one embodiment. The communication system may include a host computer 24, a network node 16 and a WD 22, which may be those described with reference to FIGS. 4 and 5. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 9 is a flowchart illustrating an example method implemented in a communication system, such as, for example, the communication system of FIG. 4, in accordance with one embodiment. The communication system may include a host computer 24, a network node 16 and a WD 22, which may be those described with reference to FIGS. 4 and 5. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

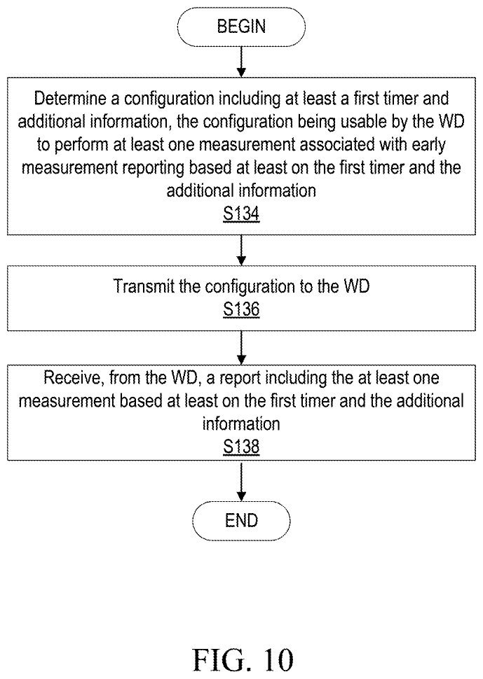

FIG. 10 is a flowchart of an example process in a network node 16. One or more blocks described herein may be performed by one or more elements of network node 16 such as by one or more of processing circuitry 68 (including the NN configuration unit 32), processor 70, radio interface 62 and/or communication interface 60. Network node 16 such as via processing circuitry 68 and/or processor 70 and/or radio interface 62 and/or communication interface 60 is configured to determine (Block S134) a configuration including at least a first timer and additional information, where the configuration is usable by the WD 22 to perform at least one measurement associated with early measurement reporting based at least on the first timer and the additional information; transmit (Block S136) the configuration to the WD 22; and receive (Block S138), from the WD 22, a report including the at least one measurement based at least on the first timer and the additional information.

In some other embodiments, the additional information includes a first set of performance targets and a second set of performance targets corresponding to a second timer and a third timer, respectively, the first and second sets of performance targets being associated with the at least one measurement.

In some embodiments, the first timer is based on at least the second timer and the third timer.

In an embodiment, the at least one measurement is performed one of before and after an expiration of at least one of the first timer, the second timer, and the third timer.

In another embodiment, the additional information includes at least one of carrier information associated with one or more carriers on which the at least one measurement is to be performed; and reference signal configuration usable by the WD 22 to perform the at least one measurement.

In some embodiments, the at least one measurement is performed by the WD 22 while in a low activity RRC state.

In some embodiments, the low activity RRC state comprises any one of an idle mode and an inactive mode.

In some embodiments, the measurement associated with early measurement reporting comprises a measurement is performed for multicarrier operation in a low activity RRC state.

In some embodiments, the multicarrier operation comprises one or more of carrier aggregation and dual connectivity.

In some other embodiments, the configuration further includes one or more rules to combine at least a first measurement of the at least one measurement performed by the WD 22 while in one of the idle mode and the inactive mode and a second measurement of the at least one measurement performed by the WD 22 while in a connected state.

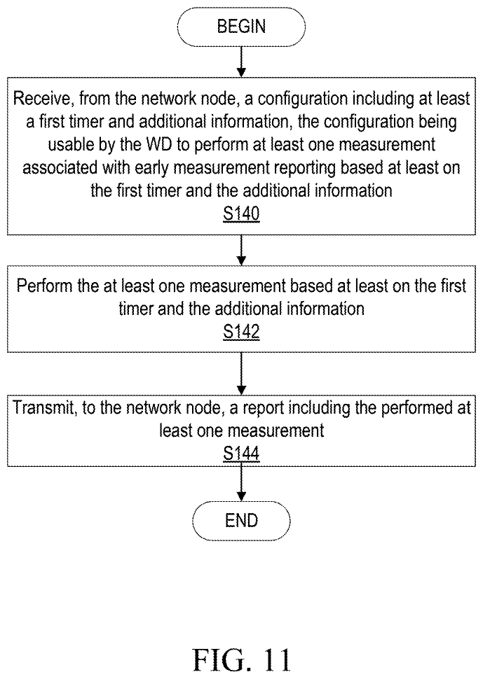

FIG. 11 is a flowchart of an example process in a wireless device 22 according to some embodiments of the present. One or more blocks described herein may be performed by one or more elements of wireless device 22 such as by one or more of processing circuitry 84 (including the WD configuration unit 34), processor 86, radio interface 82 and/or communication interface 60. Wireless device 22 such as via processing circuitry 84 and/or processor 86 and/or radio interface 82 is configured to receive (Block S140), from the network node 16, a configuration including at least a first timer and additional information, where the configuration being usable by the WD 22 to perform at least one measurement associated with early measurement reporting based at least on the first timer and the additional information; perform (Block S142) the at least one measurement based at least on the first timer and the additional information; and transmit (Block S144), to the network node 16, a report including the performed at least one measurement.

In some other embodiments, the additional information includes a first set of performance targets and a second set of performance targets corresponding to a second timer and a third timer, respectively, the first and second sets of performance targets being associated with the at least one measurement.

In some embodiments, the first timer is based on at least the second timer and the third timer.

In an embodiment, the at least one measurement is performed one of before and after an expiration of at least one of the first timer, the second timer, and the third timer.

In another embodiment, the additional information includes at least one of carrier information associated with one or more carriers on which the at least one measurement is to be performed; and reference signal configuration usable by the WD 22 to perform the at least one measurement.

In some embodiments, the at least one measurement is performed by the WD 22 while in a low activity RRC state.

In some embodiments, the low activity RRC state comprises any one of an idle mode and an inactive mode.

In some embodiments, the measurement associated with early measurement reporting comprises a measurement is performed for multicarrier operation in a low activity RRC state.

In some embodiments, the multicarrier operation comprises one or more of carrier aggregation and dual connectivity.

In some other embodiments, the configuration further includes one or more rules to combine at least a first measurement of the at least one measurement performed by the WD 22 while in one of the idle mode and the inactive mode and a second measurement of the at least one measurement performed by the WD 22 while in a connected state.

Having described the general process flow of arrangements of the disclosure and having provided examples of hardware and software arrangements for implementing the processes and functions of the disclosure, the sections below provide details and examples of arrangements for early measurement reporting.

### Embodiments in/Related to the WD

### Timer-Adaptive Procedure for EMR Measurement and Reporting

According to a first embodiment, WD 22 may be configured (e.g., using a configuration determined) by a network node 16 (e.g., serving cell) with at least a first timer (T0). The WD 22 may be further configured with information (i.e., additional information) related to one or more carrier frequencies (e.g., absolute radio-frequency channel number (ARFCN) of carriers, etc.) for performing the early measurements. The information may further comprise, for example, reference signal (RS) configuration (e.g., SB-based measurement timing configuration (SMTC), CSI-RS etc.) which enables the WD 22 to identify the RSs on which the early measurements are performed by the WD 22. During T0, the WD 22 may be further configured by the network node 16 to perform one or more early measurements in idle state and/or inactive state on one or reference signals (e.g., SSB, CSI-RS, PRS. Etc.) transmitted in one or more cells and/or by one or more beams in a cell. The first timer, T0, value further may comprise (and/or be a function of and/or be related to) at least two portions of time periods or sub-durations or subset of time periods: a first duration (T1) and a second duration (T2). T1 and T2 may also be referred as to a second timer and a third timer, respectively. The WD 22 may performs one or more measurements according to one or more rules, which may be pre-defined and/or configured by the network node 16, e.g., by receiving a message such as RRC. Examples of rules may include at least one of:
1. The WD 22 performs one or more measurements during T1 while meeting a first set of performance target (SoPT1) and/or performs one or more measurements during T2 while meeting a second set of performance target (SoPT2). At least one performance target in SoPT1 and one performance target in SoPT2 may be different. Performance targets may comprise one or more requirements associated with the measurement. Examples of requirements (i.e., measurement requirements) are measurement time, measurement accuracy requirement, number of cells to measure over certain measurement time, number of samples and sampling periodicity, radio conditions or side conditions, etc. Examples of measurement times are cell detection time, measurement period, RS index detection time (e.g., SSB index acquisition time); measurement evaluation time, etc.
   a. In one example, at least one performance target in SoPT1 is less stringent than at least one performance target in SoPT2. The less stringent requirement may also be called as more relaxed requirement.
   b. In another example, at least one performance target in SoPT1 is more stringent than at least one performance target in SoPT2. The more stringent requirement may also be called as less relaxed requirement.
   c. In another example, at least one measurement time requirement in SoPT1 is less stringent than at least one measurement time requirement in SoPT2. The measurement (e.g., RSRP) performed over longer measurement time is less stringent compared to the same type of measurement (e.g., RSRP) performed over shorter measurement time. For example, during T1 the WD 22 performs the measurement (e.g., RSRP) over first measurement time (Tm1) and during T2 the WD 22 performs the same type of measurement (e.g., RSRP) over second measurement time (Tm2); where Tm2<Tm1.
   d. In another example, the first performance target is more relaxed compared to the second performance target, at least in one requirement of the same type (e.g., fewer carriers and/or cells and/or beams to measure during the same time, more sparce sampling, less accurate measurement, longer measurement period, etc.). For example, the measurement time (e.g., cell detection or cell search time (Ts2)) for the second performance target is shorter than the measurement time (e.g., cell detection or cell search time (Ts1)) for the first performance target. In a nonlimiting example, Ts2=3*N1*T_{DRX} and Ts1=3*N1*40*T_{DRX}, where T_{DRX} is the DRX cycle length e.g., T_{DRX}=320 ms and N1 is 8.
   e. In another example, the measurement accuracy (e.g., RSRP accuracy (A2)) for the second performance target is better than the measurement accuracy (e.g., RSRP accuracy (A1)) for the first performance target. A2 may be considered to be better than A1 if the former has larger deviation with respect to a reference measurement value (e.g., ideal RSRP measured). For example, A2=+5 dB is considered to be better than A1=+7 dB.
   f. In another example, wherein the performance target is a side condition, the WD 22 is required to (i.e., may) perform the first EMR measurements of a certain accuracy in first side conditions, while it is required to perform (i.e., performing) the first EMR measurements of the same quality but in more relaxed side conditions such at a higher Es/Iot and/or higher RSRP, etc.

The WD 22 may obtain the parameters T1 and T2 based on one or more rules. The rules may be pre-defined or configured by the network node 16, e.g., by receiving a message such as RRC. Nonlimiting examples of rules are:
1. In one example of the rule(s), T0 and, T1 and T2 are related to each other by a function or relation. Examples of function are sum, average, product, minimum, maximum, less than, greater than, ceiling, floor, xth percentile, combination of two or more functions. An example of the general function relating T0 with T1 and T2 is as follows:

$$T 0 = f ( T 1 , T 2 )$$

2. In one example, T0 can be expressed as follows:

$$T 0 = T 1 + T 2$$

3. In another example, T0 can be expressed as follows:

$$T 0 < ( T 1 + T 2 )$$

4. In another example, T1 and/or T2 may be configured as timer(s). In one example both T1 and T2 are configured by the network node 16, e.g., as timers. In another example, both T1 and T2 are predefined, e.g., timer values are fixed, or their values are derived by the WD 22 based on a rule (as describe further). In another example, one of T1 and T2 is predefined, and the other one is derived by the WD 22, e.g., based on a rule (as describe further). For example, T1 starts at the same time when T0 starts. In one example, T2 starts at the time when T1 stops. In another example, T2 starts St time period after T1 stops, e.g., &t can be pre-defined or determined based on a rule such as L1 number of time resources or L2 number of discontinuous reception (DRX) cycles etc.
5. In another example, T1 and/or T2 depend on the value of T0. For example, T1 is X1% of T0 and T2 is X2% of T0. Examples of X1 and X2 are 70 and 30 respectively. In another example, if T0 is below certain threshold (H1), then T1=X3% of T0 otherwise T1=X4% of T0. In one example, X3<X4. In another example, X3=70 and X4=100.
6. In another example, T1 and T2 are related to each other by a function or a relation. In one example, T1≤T2. In another example T2 is at least X5% of T1 e.g., X5=40.
7. In another example, the values of T1 and/or T2 depend on number of measurements obtained by the WD 22 during certain time period.
   a. For example, the WD 22 may adapt or adjust the values of T1 and/or T2 depend on number of measurements obtained by the WD 22 during certain time period. For example, while T0 is running and if the WD 22 has obtained at least K1 number of measurements then T2=X6% of T0; otherwise, T2=X7% of T0. In one example, X6<X7. In one example, X6=0 and X7=30. The value of K1 (K1≥1) can be pre-defined or configured. In one example, K1=1.
      i. In one specific example, if the WD 22 has performed at least K1 number of measurements (e.g., identified at least K1 number of cells) while T0 is running then the WD 22 adapts the value of T1 as T1=T0 and T2=0. Otherwise, the WD 22 may set T1=T0−T2; and T2>0 (e.g., T2=1/k*T0); where k>1.
   b. In another example, if the WD 22 has obtained at least K2 number of measurements by the expiry of T0, then T1=T0 and T2=0; otherwise T1=T0 and T2>0. In the latter case, value of T2 may further depend on time required to obtain at least K3 number of measurements. For example, T2 runs until the WD 22 has obtained (or completed) at least K3 number of measurements. In one example, K2=K3. The values of K2 and K3 (K2≥1; K3≥1) can be pre-defined or configured. In one example, K2=1 and K3=1.
      i. In one specific example, if the WD 22 has performed at least K2 number pf measurements (e.g., identified at least K2 number of cells) until the expiry of T0 then the WD 22 adapts the value of T1 as T1=T0 and T2=0. Otherwise, upon expiry of T0, the WD 22 starts T2, which runs until the WD 22 performed at least K3 number of measurements starting from T0.
      ii. In another specific example, if the WD 22 has performed at least K2 number of measurements (e.g., identified at least one cell) until the expiry of T0, then the WD 22 does not or is not expected to perform any further measurement. Otherwise, the WD 22 continues and complete the ongoing measurements even after the expiry of T0. For example, in the latter case after expiry of T0, the WD 22 starts T2 and ends T2 when the WD 22 has obtained at least K3 number of measurements.
8. In another example of the rule, the WD 22 further performs or continues to perform the measurement after the expiry of T0 while meeting at least the second set of performance target (SoPT2). The WD 22 may perform the measurement after the expiry of T0 during at least T2, which may start when T0 expires or when T1 expires. In one example, T2 expires or is stopped after pre-defined value or configured value. For example, the WD 22 stops T2 when the WD 22 transmits the measurement results to the network node 16, e.g., in RRC resume message. Examples of measurement rules (e.g., based on this principles) are:
   a. In one example, during T0 or T1 or T2, the WD 22 may measure on cells and/or beams which have already been known to the WD 22. The cell or beam (e.g., SSB, CSI-RS) is known to the WD 22 if it has been identified or detected by the WD 22 and is measured by the WD 22 at least once in the last Y1 seconds (e.g., Y1=5); otherwise, the cell or beam may be unknown to the WD 22.
   b. In another example, during T0 or T1 or T2 and after WD 22 performing cell detection measurement, the WD 22 may continue to measure the known cells and/or beams at least once every Y1 seconds. This may ensure that the measurement results (e.g., RSRP, L1-RSRP, cell ID, SSB index) reported by the WD 22 to the network node 16 are valid (i.e., cells and/or beams are known). Measurement results of the unknown cell or beam may be unreliable and not suitable for CA/DC operation.
9. In another example, the WD 22 further performs or continues to perform the measurement during a third time period (T3), which occurs or starts when the WD 22 moves in RRC connected state. Before the start of T3, the WD 22 is in low activity RRC state, e.g., in RRC idle, RRC inactive state etc. The WD 22 may combine a first set of measurements obtained by the WD 22 before the start of T3 and a second set of measurements obtained by the WD 22 during T3. In one example, the WD 22 may obtain the first set of measurements during one or more of the following: while T0 is running, during T1, during T2, after T2 and until certain time instance occurring before the WD 22 moves to RRC connected state or until the start of T3, etc. The combining of the two sets of measurements may be performed by the WD 22 based on a function of the first set of measurements and the second set of measurements. Examples of functions are sum, average, product, difference, ceiling, floor, ratio, xth percentile product, combination of two or more functions, etc. The first set and the second set of measurements may be performed by the WD 22 on one or more cells and/or on one or more beams (e.g., SSB). The WD 22 may further report, to a network node 16, the obtained measurement results.
   a. In one example, WD 22 may store the measurements performed in first instance of less active state till the time WD 22 is configured to go to second instance of less active state (i.e., WD 22 stores the measurement performed in 1^{st} instance of less active state (RRC Idle or RRC Inactive) and transitioned to 1^{st} instance of RRC connected state and transitioned back to 2^{nd} instance of less active state) and combine these two measurements for taking the fresh measurements in the 2^{nd} instance of less active state. This may be particularly useful if WD 22 goes to IDLE/Connected states more frequently.

According to another aspect of the first embodiment, the WD 22 transmits, to a network node 16, the measurement results obtained during the EMR measurement procedure, according to one or more rules based on performance target of the measurements. In one example, when transmitting the measurement results to the network node 16, the WD 22 may group the measurement results based on the performance targets considered. For example, the measurements may be split in different structures/groups/lists which are associated with their respective performance targets considered.

In yet another example, the WD 22 may indicate whether the EMR measurement was performed during T0 or T1 or T2 and/or meeting the first performance target or the second performance target (the indication may be implicit or explicit).

### Embodiments in/Related to the Network Node

### Network Node Methods for the Time Adaptive EMR Measurement and Reporting

In the first network embodiment (i.e., first embodiment in a network node 16): a method in a network node 16, e.g., to configure a WD 22 for early measurements in idle or inactive mode is described. The method may include one or more of the following steps:
1. Transmit, to the WD 22, a configuration of at least a timer T0 and one or more carrier frequencies (e.g., ARFCN of carriers etc.) for performing the early measurements.
   a. In one example, network node 16 may configure WD 22 with explicit values of T1 and T2 along with T0.
   b. In another example, network node 16 may configure WD 22 to derive T1 and T2 based on T0 (in one example T1 may be X1% T0 and T2 may be X2% T0).
   c. In another example, network node 16 may configure WD 22 to adapt the T1 and T2 timer values based on the number of measurements performed by the WD 22 during T0 or at the end of T0.
   d. In another example, network node 16 may configure criteria for WD 22 to extend the T2 timer after WD 22 transmit RRC resume request or after receiving RRC setup request. An example criterion may be number of measurements performed when T2 is about to expire or received the RRC setup request.
2. Configure the WD 22 with a set of performance targets and/or rules (e.g., when to apply each performance target) for applying the performance targets for early measurements.
3. Configure the WD 22 with rules to combine the measurements performed in less active state (e.g., RRC_IDLE or RRC inactive) and RRC connected state and between two successive less active states.
   a. In one example, network node 16 may configure WD 22 to store the measurements performed in first less active state until the time WD 22 is configured to go to second less active state (i.e., WD 22 was in 1^{st} instance of less active, transitioned to 1^{st} instance of connected state, and transitioned back to 2^{nd} instance of less active state) and combine these two measurements for taking the fresh measurements in the 2^{nd} instance of less active state.

In one specific example, the network node 16 configures the WD 22 to perform early measurements with a set of performance target that are more stringent (e.g., including that the measurements are performed more often) during the first time period after the transition from RRC_CONNECTED to RRC_IDLE/RRC_INACTIVE, compared to the time period which occurs after that. This way, in cases where the WD 22 typically frequently transitions between RRC_CONNECTED and RRC_IDLE or RRC_INACTIVE state, and then remains in RRC_IDLE or RRC_INACTIVE for a short time period, the network node 16 can ensure that the WD 22 performs more stringent measurements while in RRC_IDLE/RRC_INACTIVE. The WD 22 may perform more reliable (stringent) measurements while in RRC_IDLE or RRC_INACTIVE, e.g., which enables a quicker setup of CA or DC configuration when entering RRC_CONNECTED. In case the WD 22 stays in RRC_IDLE or RRC_INACTIVE for a longer time (i.e., longer than a predetermined threshold), the WD 22 may perform less stringent early measurements after some time (i.e., a predetermined time), which may limit power consumption for the WD 22.

In another specific example, the network node 16 configures the WD 22 to perform early measurements with more stringent performance targets during the last part of the timer T0, e.g., the last time period before timer T331 expires, compared to a prior time period. The WD 22 may then be configured to perform early measurements with less stringent performance target(s), i.e., that are more relaxed, during the first part of timer T331, whereas more stringent performance targets are applicable during the last part of timer T331. This way, the network node 16 can ensure that the WD 22 would have more reliable measurement results available in case they are to be reported after expiry of timer T331.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object-oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
3GPP 3rd Generation Partnership Project
5G Fifth Generation
ACK Acknowledgement
AR Augmented Reality
BPS Body proximity sensing
BWP Bandwidth Part
CE Control Element
CN Core Network
CPU Central processing unit
CSI Channel State Information
CSI-RS Channel State Information Reference Signal
DCI Downlink Control Information
DL Downlink
DMRS Demodulation Reference Signal
DSP Digital signal processor
EIRP Effective Isotropic Radiated Power
eMBB Enhanced Mobile Broadband
EMR Early Measurement Reporting
FBE Frame Based Equipment
FDD Frequency Division Multiplexing
HARQ Hybrid Automatic Repeat Request
LBE Load Based Equipment (LBE)
LBT Listen Before Talk
LTE Long-Term Evolution
MAC Medium Access Control
MPE Maximum permissible exposure
MTC Machine Type Communication
NACK Negative acknowledgement
NR New Radio
OFDM Orthogonal Frequency Division Multiplexing
OPP Operating performance point
PDCCH Physical Downlink Control Channel
PDSCH Physical Downlink Shared Channel
P-MPR Power Management Maximum Power Reduction
PRB Physical Resource Block
PTRS Phase Tracking Reference Signal
PUCCH Physical Uplink Control Channel
PUSCH Physical Uplink Shared Channel
RA Random access
RAN Radio Access Network
RB Resource Block
RRC Radio Resource Control
SRS Sounding Reference Signal
TAG Timing advance group
TAT Time alignment timer
TB Transport Block
TDD Time Division Multiplexing
TTI Transmission Time Interval
TRP Total Radiated Power
UE User Equipment
UL Uplink
UL-SCH Uplink Shared Channel
URLLC Ultra-Reliable and Low Latency Communication
VR Virtual Reality
VRB Virtual Resource Block
XR Extended Reality

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings and/or following example embodiments.

### EXAMPLE EMBODIMENTS

Embodiment A1. A network node configured to communicate with a wireless device (WD), the network node configured to, and/or comprising a radio interface and/or comprising processing circuitry configured to:
determine a configuration including at least a first timer and additional information, the configuration being usable by the WD to perform at least one measurement associated with early measurement reporting based at least on the first timer and the additional information;
transmit the configuration to the WD; and
receive, from the WD, a report including the at least one measurement based at least on the first timer and the additional information.

Embodiment A2. The network node of Embodiment A1, wherein the additional information includes a first set of performance targets and a second set of performance targets corresponding to a second timer and a third timer, respectively, the first and second sets of performance targets being associated with the at least one measurement.

Embodiment A3. The network node of any one of Embodiments A1-A2, wherein the first timer is based on at least the second timer and the third timer.

Embodiment A4. The network node of any one of Embodiments A2 and A3, wherein the at least one measurement is performed one of before and after an expiration of at least one of the first timer, the second timer, and the third timer.

Embodiment A5. The network node of any one of Embodiments A1-A4, wherein the additional information includes at least one of:
carrier information associated with one or more carriers on which the at least one measurement is to be performed; and
reference signal configuration usable by the WD to perform the at least one measurement.

Embodiment A6. The network node of any one of Embodiments A1-A5, wherein the at least one measurement is performed by the WD while in a low activity RRC state.

Embodiment A7. The network node of any one of Embodiments A1-A6, wherein the low activity RRC state comprises any one of an idle mode and an inactive mode.

Embodiment A8. The network node of any one of Embodiments A1-A7, wherein the measurement associated with early measurement reporting comprises a measurement is performed for multicarrier operation in a low activity RRC state.

Embodiment A9. The network node of any one of Embodiments A1-A8, wherein the multicarrier operation comprises one or more of carrier aggregation and dual connectivity.

Embodiment A10. The network node of Embodiments A6-A9, wherein the configuration further includes one or more rules to combine at least a first measurement of the at least one measurement performed by the WD while in one of the idle mode and the inactive mode and a second measurement of the at least one measurement performed by the WD while in a connected state.

Embodiment B1. A method implemented in a network node, the method comprising:
determining a configuration including at least a first timer and additional information, the configuration being usable by the WD to perform at least one measurement associated with early measurement reporting based at least on the first timer and the additional information;
transmitting the configuration to the WD;
receiving, from the WD, a report including the at least one measurement based on the transmitted configuration.

Embodiment B2. The method of Embodiment B1, wherein the additional information includes a first set of performance targets and a second set of performance targets corresponding to a second timer and a third timer, respectively, the first and second sets of performance targets being associated with the at least one measurement.

Embodiment B3. The method of Embodiment B2, wherein the first timer is based on at least the second timer, and the third timer.

Embodiment B4. The method of any one of Embodiments B2 and B3, wherein the at least one measurement is performed one of before and after an expiration of at least one of the first timer, the second timer, and the third timer.

Embodiment B5. The method of any one of Embodiments B1-B4, wherein the additional information includes at least one of:
carrier information associated with one or more carriers on which the at least one measurement is to be performed; and
reference signal configuration usable by the WD to perform the at least one measurement.

Embodiment B6. The method of any one of Embodiments B1-B5, wherein the at least one measurement is performed by the WD while in a low activity RRC state.

Embodiment B7. The method of any one of Embodiments B1-B6, wherein the low activity RRC state comprises any one of an idle mode and an inactive mode.

Embodiment B8. The method of any one of Embodiments B1-B7, wherein the measurement associated with early measurement reporting comprises a measurement is performed for multicarrier operation in a low activity RRC state.

Embodiment B9. The method of any one of Embodiments B1-B8, wherein the multicarrier operation comprises one or more of carrier aggregation and dual connectivity.

Embodiment B10. The method of any one of Embodiments B6-B9, wherein the configuration further includes one or more rules to combine at least a first measurement of the at least one measurement performed by the WD while in one of the idle mode and the inactive mode and a second measurement of the at least one measurement performed by the WD while in a connected state.

Embodiment C1. A wireless device (WD) configured to communicate with a network node, the WD configured to, and/or comprising a radio interface and/or processing circuitry configured to:
receive, from the network node, a configuration including at least a first timer and additional information, the configuration being usable by the WD to perform at least one measurement associated with early measurement reporting based at least on the first timer and the additional information;
perform the at least one measurement based at least on the first timer and the additional information; and
transmit, to the network node, a report including the performed at least one measurement.

Embodiment C2. The WD of Embodiment C1, the additional information includes a first set of performance targets and a second set of performance targets corresponding to a second timer and a third timer, respectively, the first and second sets of performance targets being associated with the at least one measurement.

Embodiment C3. The WD of any one of Embodiments C1-C2, wherein the first timer is based on at least the second timer and the third timer.

Embodiment C4. The WD of any one of Embodiments C2 and C3, wherein the at least one measurement is performed one of before and after an expiration of at least one of the first timer, the second timer, and the third timer.

Embodiment C5. The WD of any one of Embodiments C1-C4, wherein the additional information includes at least one of:
carrier information associated with one or more carriers on which the at least one measurement is to be performed; and
reference signal configuration usable by the WD to perform the at least one measurement.

Embodiment C6. The WD of any one of Embodiments C1-C5, wherein the at least one measurement is performed by the WD while in a low activity RRC state.

Embodiment C7. The WD of any one of Embodiments C1-C6, wherein the low activity RRC state comprises any one of an idle mode and an inactive mode.

Embodiment C8. The WD of any one of Embodiments C1-C7, wherein the measurement associated with early measurement reporting comprises a measurement is performed for multicarrier operation in a low activity RRC state.

Embodiment C9. The WD of any one of Embodiments C1-C8, wherein the multicarrier operation comprises one or more of carrier aggregation and dual connectivity.

Embodiment C10. The WD of any one of Embodiments C6-C9, wherein the configuration further includes one or more rules to combine at least a first measurement of the at least one measurement performed by the WD while in one of the idle mode and the inactive mode and a second measurement of the at least one measurement performed by the WD while in a connected state.

Embodiment D1. A method implemented in a wireless device (WD), the method comprising:
receiving, from the network node, a configuration including at least a first timer and additional information, the configuration being usable by the WD to perform at least one measurement associated with early measurement reporting based at least on the first timer and the additional information;
performing the at least one measurement based at least on the first timer and the additional information; and transmitting, to the network node, a report including the performed at least one measurement.

Embodiment D2. The method of Embodiment D1, wherein the additional information includes a first set of performance targets and a second set of performance targets corresponding to a second timer and a third timer, respectively, the first and second sets of performance targets being associated with the at least one measurement.

Embodiment D3. The method of any one of Embodiments D1-D2, wherein the first timer is based on at least the second timer and the third timer.

Embodiment D4. The method node of any one of Embodiments D2 and D3, wherein the at least one measurement is performed one of before and after an expiration of at least one of the first timer, the second timer, and the third timer.

Embodiment D5. The method of any one of Embodiments D1-D4, wherein the additional information includes at least one of:
carrier information associated with one or more carriers on which the at least one measurement is to be performed; and
reference signal configuration usable by the WD to perform the at least one measurement.

Embodiment D6. The method of any one of Embodiments D1-D5, wherein the at least one measurement is performed by the WD while in a low activity RRC state.

Embodiment D7. The method of any one of Embodiments D1-D6, wherein the low activity RRC state comprises any one of an idle mode and an inactive mode.

Embodiment D8. The method of any one of Embodiments D1-D7, wherein the measurement associated with early measurement reporting comprises a measurement is performed for multicarrier operation in a low activity RRC state.

Embodiment D9. The method of any one of Embodiments D1-D8, wherein the multicarrier operation comprises one or more of carrier aggregation and dual connectivity.

Embodiment D10. The method of any one of Embodiments D6-D9, wherein the configuration further includes one or more rules to combine at least a first measurement of the at least one measurement performed by the WD while in one of the idle mode and the inactive mode and a second measurement of the at least one measurement performed by the WD while in a connected state.

1. A method implemented in a wireless device (WD), the method
comprising:
receiving, from a cell on which the WD is camped, a configuration being usable by the WD to perform at least one measurement associated with early measurement reporting, the configuration further indicating: one or more rules being usable by the WD to combine a first measurement of the at least one measurement associated with early measurement reporting, with a second measurement performed by the WD, where the second measurement is another measurement of at least one measurement performed by the WD while in a low activity RRC state, or a measurement performed by the WD while in a connected state;
performing the at least one measurement according to the configuration;
obtaining a measurement result according to at least part of the one or more rules to combine the first measurement and the second measurement; and
transmitting, to the network node, a report including the obtained measurement result.

2. The method of claim 1, wherein the low activity RRC state comprises any one of an idle mode and an inactive mode.

3. The method of claim 1, wherein the at least one measurement associated with early measurement reporting comprises a measurement performed for multicarrier operation in a low activity RRC state.

4. The method of claim 3, wherein the multicarrier operation comprises one or more of carrier aggregation and dual connectivity.

5. The method of claim 1, wherein the one or more rules to combine comprise one of following functions:
sum;
average;
product;
difference;
ceiling;
floor;
ratio;
xth percentile product; or
combination of two or more of the above functions.

6. A wireless device (WD) configured to communicate with a cell on which the WD is camped, the WD comprising one or both of a radio interface and processing circuitry configured to:
receive, from the cell, a configuration being usable by the WD to perform at least one measurement associated with early measurement reporting, the configuration further indicating: one or more rules being usable by the WD to combine a first measurement of the at least one measurement associated with early measurement reporting, with a second measurement performed by the WD, where the second measurement is another measurement of at least one measurement performed by the WD while in a low activity RRC state, or a measurement performed by the WD while in a connected state;
perform the at least one measurement according to the configuration;
obtain a measurement result according to at least part of the one or more rules to combine the first measurement and the second measurement; and
transmit, to the cell, a report including the obtained measurement result.

7. The WD of claim 6, wherein the low activity RRC state comprises any one of an idle mode and an inactive mode.

8. A method implemented by a network node serving a cell on which a wireless device, WD, is camped, the method comprising:
transmitting a configuration to the WD, the configuration being usable by the WD to perform at least one measurement associated with early measurement reporting, the configuration further indicating: one or more rules being usable by the WD to combine a first measurement of the at least one measurement associated with early measurement reporting, with a second measurement performed by the WD, where the second measurement is another measurement of at least one measurement performed by the WD while in a low activity RRC state, or a measurement performed by the WD while in a connected state; and
receiving, from the WD, a report including result of combination of the first and second measurement.

9. The method of claim 8, wherein the low activity RRC state comprises any one of an idle mode and an inactive mode.

10. The method of claim 8, wherein the at least one measurement associated with early measurement reporting comprises a measurement performed for multicarrier operation in a low activity RRC state.

11. The method of claim 10, wherein the multicarrier operation comprises one or more of carrier aggregation and dual connectivity.

12. The method of claim 8, wherein the one or more rules to combine comprise one of following function:
sum;
average;
product;
difference;
ceiling;
floor;
ratio;
xth percentile product; or
combination of two or more of the above functions.

13. (canceled)

14. (canceled)

15. The method of claim 2, wherein the at least one measurement associated with early measurement reporting comprises a measurement performed for multicarrier operation in a low activity RRC state.

16. The method of claim 15, wherein the multicarrier operation comprises one or more of carrier aggregation and dual connectivity.

17. The method of claim 2, wherein the one or more rules to combine comprise one of following functions:
sum;
average;
product;
difference;
ceiling;
floor;
ratio;
xth percentile product; or
combination of two or more of the above functions.

18. The WD of claim 6, wherein the at least one measurement associated with early measurement reporting comprises a measurement performed for multicarrier operation in a low activity RRC state.

19. The WD of claim 18, wherein the multicarrier operation comprises one or more of carrier aggregation and dual connectivity.

20. The WD of claim 6, wherein the one or more rules to combine comprise one of following functions:
sum;
average;
product;
difference;
ceiling;
floor;
ratio;
xth percentile product; or
combination of two or more of the above functions.

21. The method of claim 9, wherein the at least one measurement associated with early measurement reporting comprises a measurement performed for multicarrier operation in a low activity RRC state.

22. The method of claim 21, wherein the multicarrier operation comprises one or more of carrier aggregation and dual connectivity.
